(19) United States
(12) Patent Application Publication
(10) Pub. No.: US 2022/0073291 A1
(43) Pub. Date: Mar. 10, 2022

(54) Device for replacing pallet supporting a load

(71) Applicant: TOPPY S.R.L., Valsamoggia (IT)

(72) Inventor: Daniele Piani, Monte San Pietro (IT)

(21) Appl. No.: 17/422,305

(22) PCT Filed: Jan. 27, 2020
(86) PCT No.: PCT/IB2020/050608

§ 371 Date: Jul. 12, 2021

(30) Foreign Application Priority Data
Jan. 14, 2019 (IT) 102019000000571

(51) Int. Cl. B65G 61/00

(52) U.S. Cl. CPC B65G 61/00; B65G 2201/0267

(57) ABSTRACT

A device for replacing a pallet to be replaced (P) supporting a load (C) with a replacing pallet (S) a bulkhead element (9) connected between uprights (7) and vertically spaced from a slide element (3) by at least the height of the pallet to be replaced (P) so as to form a window (11) for passage of the pallet to be replaced (P) therethrough. The pallet to be replaced (P) and the load (C) are moved into an exchange site (I) in front of the window (11) and in abutment with it, or facing and adjacent to, the bulkhead element (9), wherein a force exerted on the pallet to be replaced (P) by the replacing pallet (S) causes the latter to be inserted (S) under the load and the pallet to be replaced (P) to move away beyond the window until it reaches a collecting site (R).

### TECHNICAL FIELD

The present invention relates to the technical field concerning packaging and handling of palletized loads and refers to a device for replacing a pallet supporting a load consisting, for example, of boxes containing goods or merchandise.

### BACKGROUND ART

In the logistics management of goods, for example of the type in which goods or products are contained in boxes that are arranged in groups ordered on pallets or paddles (hereinafter referred to as pallets) by palletizing these boxed goods, it may be useful or indispensable to transfer the boxes that make up the load of an original pallet to another replacing pallet.

One possibility of carrying out this operation manually is to place a replacing pallet next to the original pallet on which the boxes constituting the respective load are placed, and to move the boxes of the load one by one by one making again the palletized load by placing them on the replacing pallet, where the lower boxes were the highest and where these boxes are supported by the replacing pallet.

In order to avoid the time and economic burdens and the safety risks of this way of proceeding, machines have been made that are able to separate the load from the original pallet, for example by lifting all the palletized goods, rotating upside down this set of goods and original pallet by placing the latter upside down to remove it and replace it with the replacing pallet; a further upside down rotation and translation downwards brings the replacing pallet in a lower position and on the ground, obtaining again the palletization of the goods.

The need to replace the original pallet supporting the respective load consisting of the palletized goods, may derive from the need to remove the original pallet because it is contaminated or infested or subject to such risks and to replace it with one that is certainly free from contamination and/or infestation or to replace pallets of one standard with others of a different standard or of a special kind.

Devices known to replace pallets of palletized goods have the disadvantage of being very complex and very expensive.

Another disadvantage of such known devices is that they are very bulky.

A further disadvantage of such known devices is that they may require operational access from several sides.

Another disadvantage is that these known devices do not allow the loads of two or more original pallets to be superimposed on a single replacing pallet to solve problems or to optimize the management and/or storage of the palletized goods and/or to reduce the number of replacing pallets involved.

### DISCLOSURE OF INVENTION

One purpose of the present invention is to propose a device for the replacement of a pallet supporting a load that is relatively simple, economical, reliable, and versatile for operators with pallets and loads of almost any type.

Another purpose is to propose a device that is small in size and does not involve maneuvering in areas that extend beyond its base.

A further purpose is to propose a device that is able to accumulate the original pallets and allow them to be removed at the front or rear of the device.

Another purpose is to propose a device that can be used with palletized goods with pallets and loads of different sizes and types.

A further purpose is to propose a device capable of superimposing the loads of two or more original pallets on a single replacing pallet.

Another purpose is to propose a device free of active push elements for the sliding of the pallets and which allows this sliding to be carried out by means of forklifts or other means for moving the pallets with and without the loads.

Document N. CN 201 284 149 discloses a device for changing a pallet having a load where a front baffle, a central baffle and a back baffle, in cooperation with a platform unit jointly surround a stacking space for storing a stack of replacing pallets and a replacement space for a main pallet (to be replaced) and the respective load consisting of goods. The front baffle, the central baffle and the back baffle are mutually parallel, and each is provided with a port respectively driving, replacement and back for the passage of the pallets.

A drive circuit comprises hydraulic rods for translating forward and backward a push plate assigned to translate the pallets through the abovementioned ports. The translation orientation of the push plate and of the pallets is perpendicular to the baffles. The reference numbers are adherent to the references of the figures of document N. CN 201 284 149. Due to the features of document N. CN 201 284 149, above mentioned and that can be seen from the same document, the stack of pallets and the main pallet with the respective load of goods and the load supported by the replacing pallet must be positioned in the respective stacking space and replacement space with movement oriented parallelly to the baffles, for avoiding the collision with them, and obviously perpendicularly in respect to the orientation of the translation of the push plate and of the pallets.

The device of document N. CN 201 284 149 could be bulky, requires large surrounding areas for loading, unloading and moving the stack of pallets, the main pallets with loads and without loads. Said prior art document need an active drive unit or at least a sliding pushing plate.

### BRIEF DESCRIPTION OF THE DRAWINGS

The features of the invention are highlighted hereinafter, with specific reference to the schematic drawings, in which:

FIG. 1 shows an axonometric view of the device for replacing of a pallet to be replaced supporting a load with a replacing pallet object of the present invention in a condition of readiness for operation in which such device is fixed to a horizontal floor;

FIG. 2 shows a side view of the device of FIG. 1;

FIG. 3 shows a rear view of the device of FIG. 1;

FIG. 4 shows a top view of the device of FIG. 1;

FIG. 5 shows a sectional view from a longitudinal plane and in which certain parts of the device of FIG. 1 have been removed, in which a bulkhead element and a bracket element are in a vertical position;

FIG. 6 shows another sectioned view from a longitudinal plane in which certain parts of the device of FIG. 1 have been removed, in which the bulkhead element and the bracket element are in another vertical position, different from that shown in FIG. 5;

FIG. 7 shows an axonometric and enlarged view of a coupling member of FIG. 1 and some parts connected thereto;

FIG. 8 shows an enlarged and partial view of the device of FIG. 2 associated with a pallet to be replaced already separated from the respective load;

FIG. 9 shows the elements of FIG. 8 in a condition in which the pallet to be replaced is moved by a pushing bar of a device push element;

FIG. 10 shows an axonometric enlarged view in which some parts have been removed from the push element connected to other parts of the device;

FIG. 11 shows a sectioned and partial view of the portion of the device of FIG. 10 associated with the pallet to be replaced and to a replacing pallet;

FIG. 12 shows the elements of the device of FIG. 11 associated with the pallet to be replaced under a forward motion condition by means of the forward bar;

FIG. 13 shows the elements of the device of FIG. 11 associated with the pallet to be replaced under a further forward motion condition by means of the forward bar;

FIG. 14 shows the device in an initial operative condition;

FIG. 15 shows the load and the respective pallet to be replaced still kept lifted by the transpallet;

FIG. 16 shows the transport means with the deposited pallet to be replaced on the slide element that has been moved away leaving the pallet to be replaced while the load C remains slightly lifted;

FIG. 17 shows the transport means pushing a replacing pallet against the pallet to be replaced which starts to move while the load remains slightly lifted;

FIG. 18 shows the situation where the transport means has positioned the replacing pallet under the load and this replacing pallet has pushed the pallet to be replaced, almost completely through the window;

FIG. 19 shows the pushers have already moved away from each other the side walls that have released the load by depositing it on the replacing pallet and the transport means has picked up and is removing the replacing pallet with the overlying load;

FIG. 20 shows the transport means has removed the replacing pallet with the overlying load and the pallet to be replaced is in the same position as FIG. 19 that is with a side edge under the bulkhead element;

FIG. 21 shows that the bracket elements are lifted causing the retirement and the sliding of the respective piece of chain which, being connected to the pushing bar, rotate it moving it in the opposite direction to the access of the device, in this way the pushing bar acts on the pallet to be replaced moving it away from the window until the bracket elements are placed in the collecting site;

FIG. 22 shows that the bracket elements are lowered by placing side by side the pallet to be replaced, and pushing bar returns to its initial lowered position;

FIG. 23 the hooking members 23 of the bracket elements 21 hook the side edges of the pallet to be replaced P;

FIG. 24 shows a side view of the device associated with a stack of pallets to be replaced that have accumulated in the device following their replacement; and

FIG. 25 shows a variant of a detail of the device shown in FIG. 10.

### DETAILED DESCRIPTION

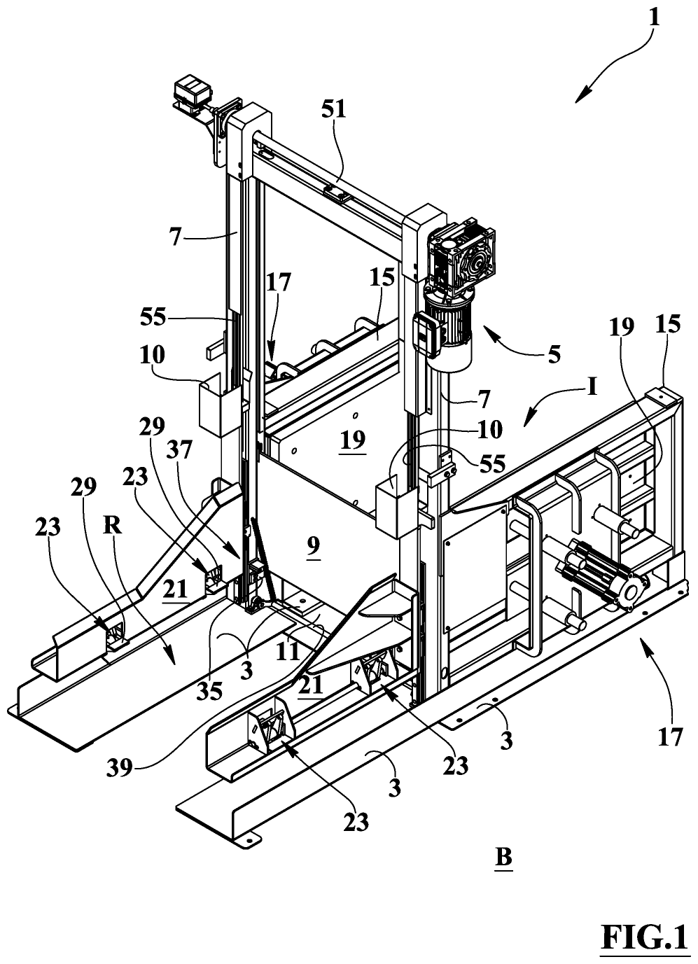

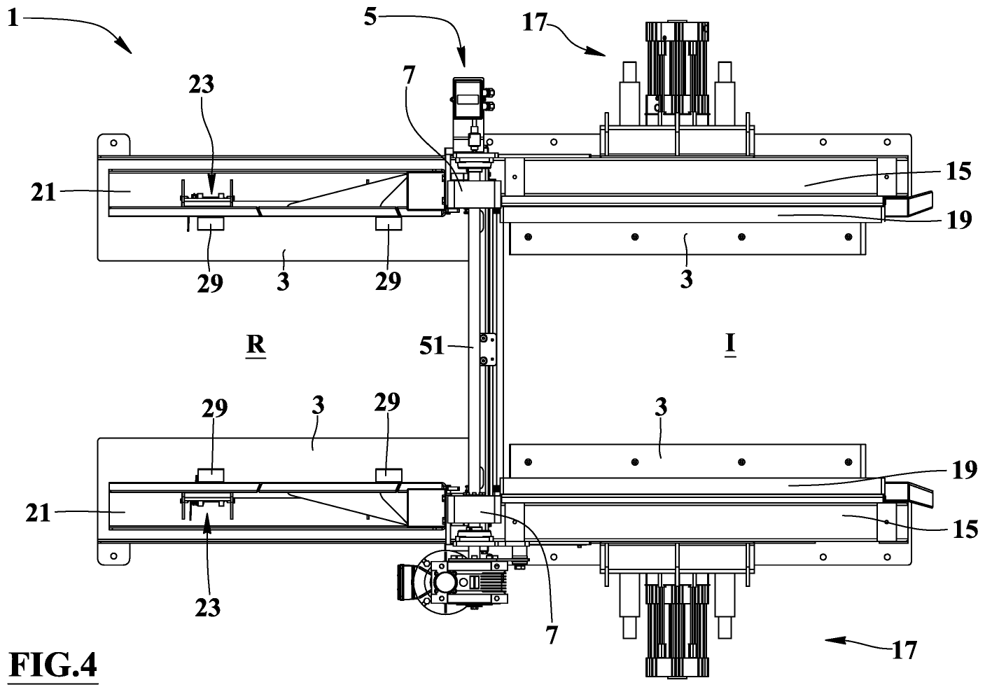

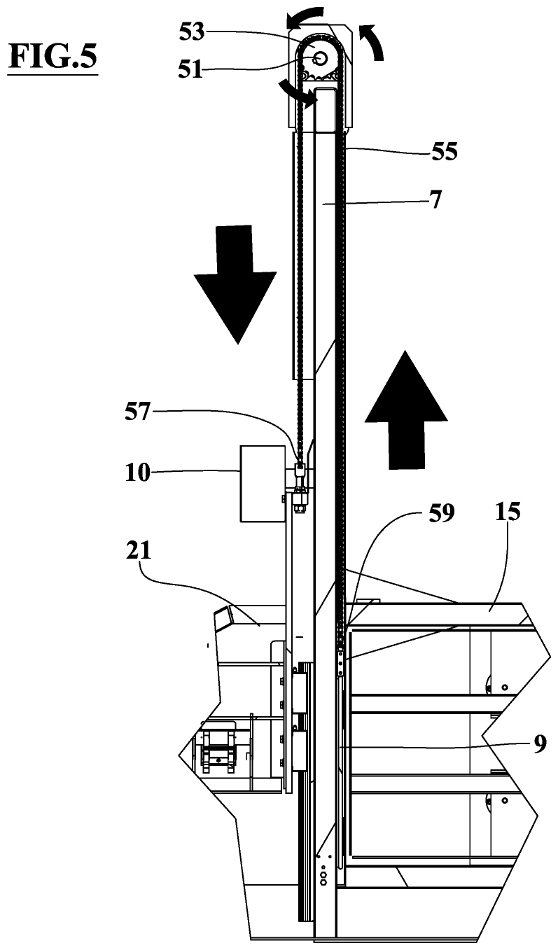

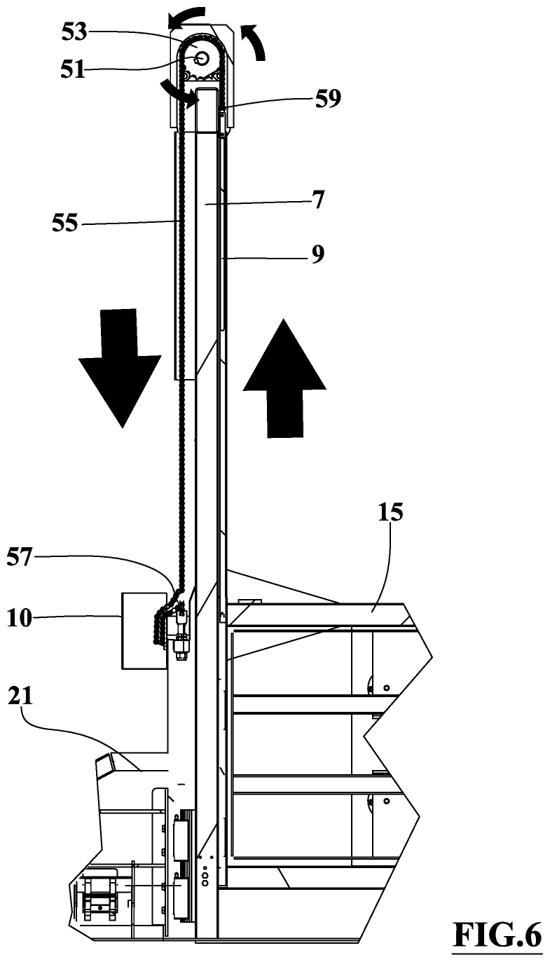

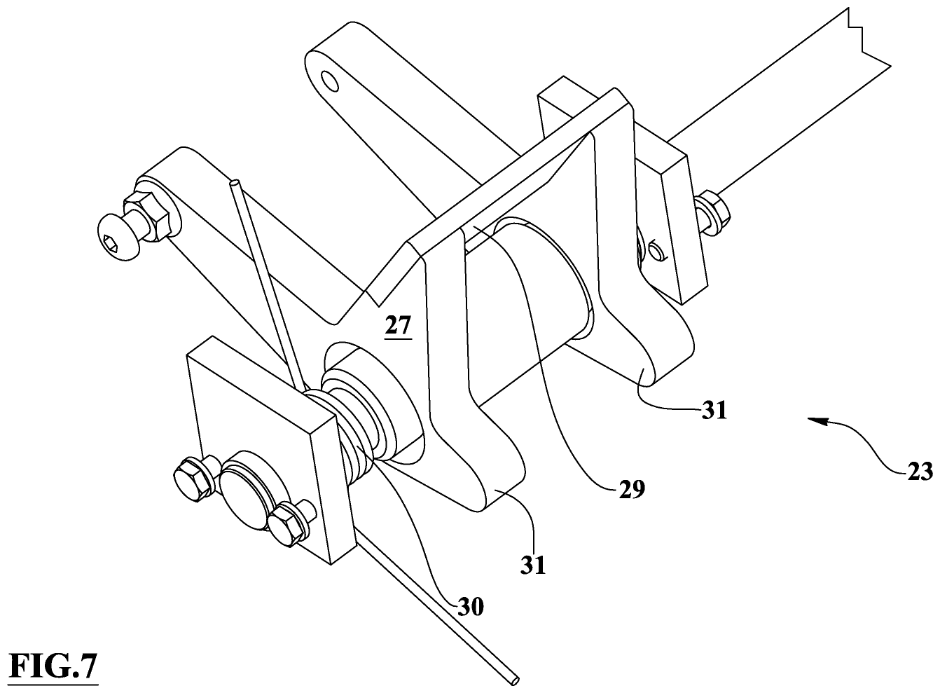

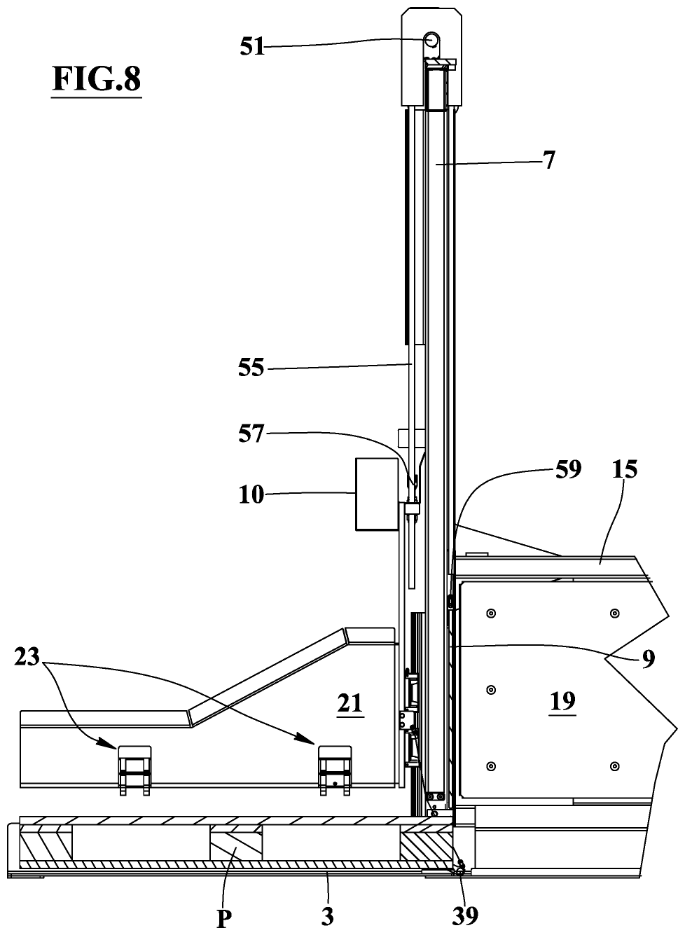

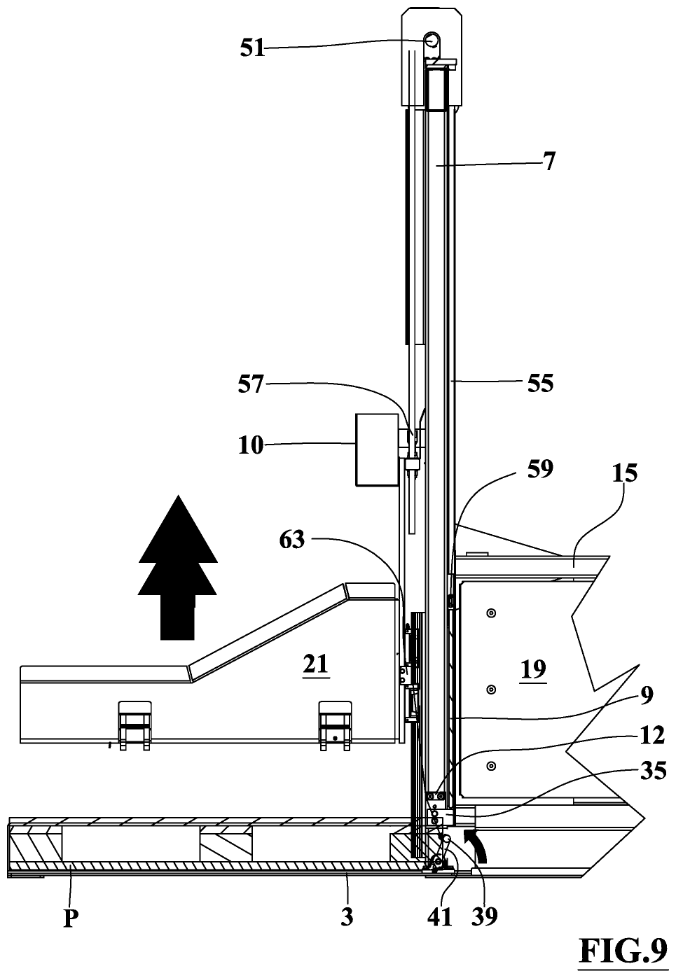

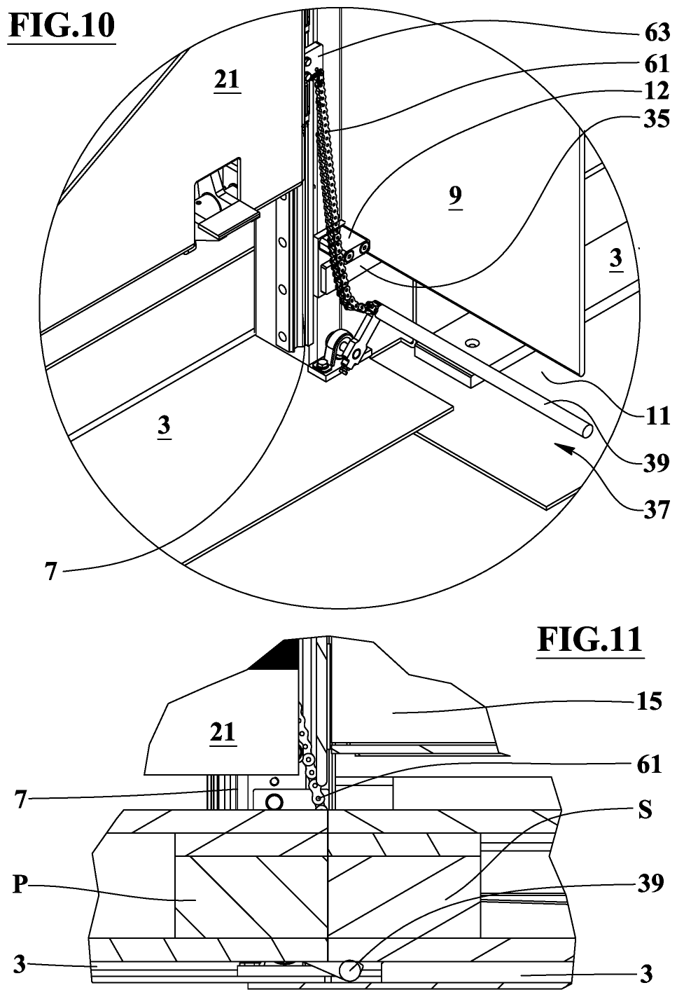

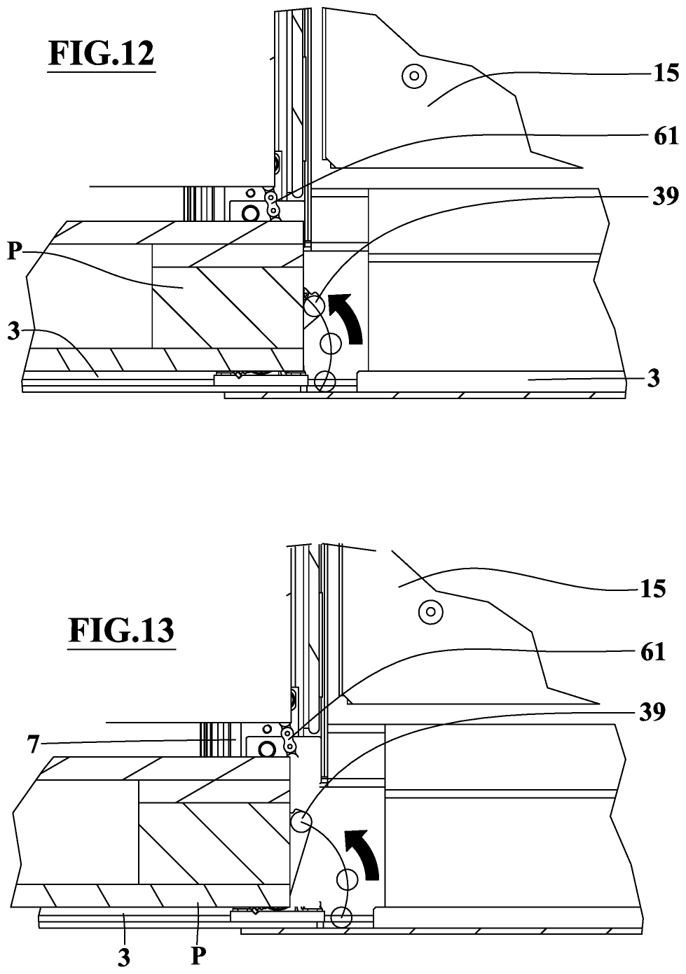

With reference to FIGS. 1-13, numeral 1 indicates the device for the replacement of a pallet supporting a load object of the present invention. The device 1, in its operative condition where it is placed on an almost horizontal floor or surface B and to which it is fixed, is assigned to allow the replacement of a pallet to be replaced P supporting a load C with a replacing pallet S; for example a package coining from a logistics chain and arrived at a device 1 installation site, may include a load, for example made up of canned goods, supported by a pallet P which, for various reasons, for example standards, construction materials, contamination risks, cost or other, must be replaced by another replacing pallet S which must take the place of the pallet to be replaced P under the load C to support it, while the pallet to be replaced P may be accumulated together with others of the same nature and then picked up and moved or evacuated.

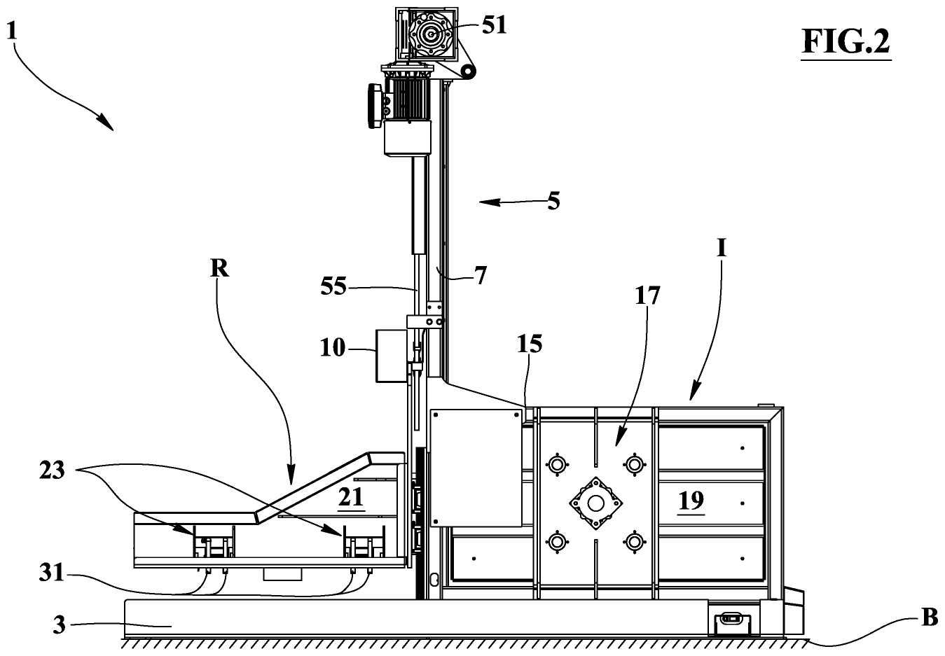

Device 1 has an access for the load supported by the pallet to be replaced; in FIGS. 1 and 2 the access is located at the right end of the device and the pallet to be replaced is moved in a longitudinal advancing direction facing the access at the opposite end of the device; said direction in such figures is from right to left along the longitudinal development of device 1.

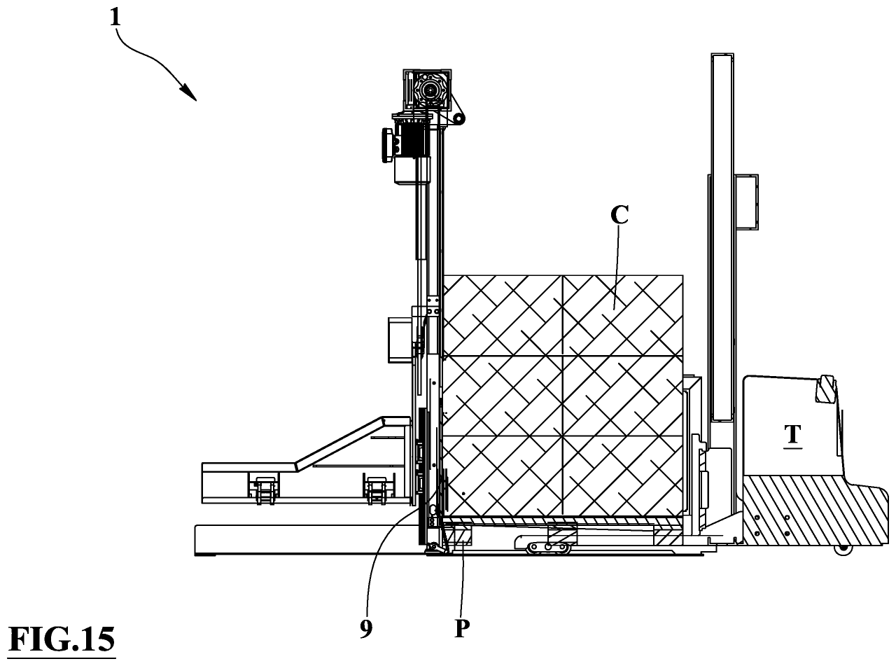

The translation of the pallet to be replaced P, with and without load C, is made by direct action or indirect push of a transport means T (FIGS. 15-19) which may consist, for example, of a lift truck or forklift or a trans-pallet or similar known devices. The picking and evacuation of the pallets to be replaced without the load and stacked, can take place from the end of the device opposite the access or, as better explained below and to facilitate the operations and/or to save space, from the access itself.

The exit of the load C supported by a replacing pallet S takes place through the access by means of the same or another transport means T.

Such device 1, in its operative condition, comprises at least:

a slide element 3 assigned to be placed on said horizontal floor or surface B and fixed thereto at least to support slidably said pallets P, S from the access in the longitudinal direction before and, if necessary, in the opposite direction thereafter, for this purpose slide element 3 has at least one sliding surface with a total width equal to or greater than that of pallets P, S and a length approximately twice the length of one of these pallets P, S or a length approximately equal to the sum of the lengths of such pallets to be replaced P and replacing S, if different;
at least one portal element 5 comprising at least a pair of uprights 7, for example consisting of extruded profiles or shaped section beams, spaced, vertical and fixed to the respective and opposite sides of the median portion of the slide element 3;
a vertical bulkhead element 9, for example flat and slab-shaped or grid, connected to said uprights 7 transversely to the slide element 3 and raised in relation to the sliding surface of the latter 3 by a predetermined distance equal to or slightly higher than the height of the pallet to be replaced P, thus forming a window 11 between the lower edge of the bulkhead element 9 and the sliding surface of the slide element 3 for the passage of the latter pallet to be replaced P.

Said slide element 3 has an elongated rectangular shape and its longitudinal geometrical axis defines a longitudinal direction which is parallel or coincident with said longitudinal forward direction of the pallets sliding on slide element 3. In the following the terms “longitudinal direction” and “longitudinal forward direction” shall be used interchangeably because they have the same orientation.

Said slide element 3 may consist of a support and sliding plane extending throughout the longitudinal development of the device from the access to the opposite end or, preferably, comprise two lateral guides parallel to the longitudinal forward direction and equipped with respective sliding surfaces for pallets P, S. Each of such guides extends longitudinally from the access to the opposite end and one or more inclined planes or ramps may be provided at the access to prevent the pallet to be replaced and/or the load from jamming.

The median portion of each of such guide is fixed at the base of a corresponding upright 7.

Such guides have respective transversal concave sites extending downwards below said sliding surfaces.

Such transversal concave sites are placed immediately upstream of the orthogonal projection of the bulkhead element 9 on the slide element 3 in relation to the longitudinal forward direction.

Thereafter the portion of the device comprised between the access and the bulkhead element 9, or its projection, shall be indicated as exchange site I and the portion of the device between the bulkhead element 9 and the slide element 3 end opposite the access shall be indicated as collecting site R.

The sections or segments of each of the sliding guides separated from the respective transversal site are the same or preferably different and the sections of the guides on the side of the exchange site I have low-drag synthetic material sliding surfaces.

Uprights 7 of the portal element 5 must oppose and counter a frictional force acting on them in the forward direction and may be equipped with struts, gussets or stalls connected to the slide element 3 or the floor to better resist such force.

Bulkhead element 9 may be rigidly blocked to uprights 7 of the portal element 5 or may be connected to such uprights 7 by means of an adjustable attachment to obtain a window 11 with a respectively fixed or adjustable height according to the height or other features of the pallets to be replaced P; alternatively, and as better described below, the bulkhead element 9 may be operated to move vertically by sliding its vertical sides along respective vertical guides cut into such uprights.

In particular, the invention also provides that bulkhead element 9 can be fixed and locked at a predetermined vertical distance from slide element 3 or can be supported by a pair of rigid or adjustable side supports to determine the minimum distance of the bulkhead element 9 from the slide element 3 so that this minimum distance is respectively fixed or adjustable. Where rigid or adjustable side supports are used, the bulkhead element 9 may always be supported by them or, as seen and described in more detail below, it may be lifted by elements provided for this purpose. It should be noted that when the bulkhead element is fixed to the uprights or supported by the pair of rigid side supports, the height of window 11 is fixed; the adoption of a pair of adjustable side supports and/or lifting elements of the bulkhead element permits to adjust the height of window 11, for example according to the various types of pallets, where such lifting elements may be dedicated to adjusting the height of the window or may be used mainly or exclusively for other function as described below.

In the operative condition, the transport means T moves the pallet to be replaced P and the respective load C in the longitudinal forward direction until they occupy the exchange site I on the slide element 3 in which such pallets to be replaced P and the respective load C are respectively in front of window 11 and in abutment with the bulkhead element 9, a forward force exerted by the same or other transport means T on the pallet to be replaced P, for example by means of at least the replacing pallet S, it causes the insertion of the latter S under the load and the removal of the pallet to be replaced P beyond the window until the collecting site R is reached on the portion of the slide element 3 opposite to the exchange site I, obtaining the support of the load C by the replacing pallet S ready for engagement with the overlying load along with disengagement of the pallet to be replaced P.

Device 1 includes a pair of side arms 15 connected to the uprights 7 of at least one portal element 5 and protruding perpendicularly from the uprights in the access direction delimiting laterally the replacement position to support the load C laterally. Such side arms 15 are preferably either flat or have faces facing the load in a flat shape where such arms and/or flat faces are arranged vertically.

Alternatively and preferably, such side arms 15 are provided with respective pushers 17 assigned to move corresponding vertical and parallel sides 19 to the uprights and to that forward direction and facing that exchange site I. Such pushers 17 comprise respective linear guides and linear translators horizontal and perpendicular to the uprights and to the forward direction where the fixed portions of such guides and actuators are fixed to the first parts of the side arms connected to the uprights and their movable portions are perpendicularly fixed to said respective side walls.

The pushers 17 move the side walls away from each other and bring them closer to each other so that they can tighten the load, stabilizing it, during the replacement of the pallet to be replaced by the replacing one and releasing it at the end of the replacement.

The side walls 19 are large enough in size to meet all or almost all the side surface of the load and their lower edges are placed at a vertical distance from the underlying portion of the slide element 3 such that they are at the same height or slightly higher than the upper edge of the pallet to be replaced P supported by the transport means T; in this way the side walls can tighten the load C without the risk of interfering with the pallet to be replaced.

Optionally, said side arms 15 can be slidably connected to the respective vertical guides (not shown) made in, or fixed to, the respective uprights 7 and the device 1 can include a lifting and lowering actuator element of each side arm 15 (actuator element not shown) along said vertical guides. Each lifting element may include, for example, a linear actuator of electric or hydraulic type or of the nut screw and motorized screw type, chain, rack and motorized pinion, etc., each having one end or element fixed to a respective upright or slide element 3 and the other end or other element fixed to the respective side arm 15.

This optional arrangement, which includes the arms and side walls 15, 19 vertically movable and whose understanding does not require specific figures, permits to lighten the pressure of the load on the pallets making it easier to slide them during their replacement and/or mainly to lift a first load by also removing the supporting pallet to insert a second load, supported by a pallet to be replaced if necessary, under the first load obtaining a pallet that supports both superimposed loads. In this way it is possible to halve the number of pallets involved and the surface area occupied.

Device 1 also includes two bracket elements 21, with an almost linear or elongated prismatic shape, parallel to the forward direction and facing in the opposite direction to the load access and the exchange site I.

Each bracket element 21 is connected to a respective upright 7 and slides vertically along the respective vertical lifting guides connected to, or made in the corresponding upright by means of at least one lifting actuator element between a lower position, in which such bracket element 21 abuts with the slide element 3 or the floor, and a higher condition in which it is lifted.

Each of these bracket elements 21 is equipped with at least one hooking member 23 assigned, in the downward end stroke of the respective slide element 3, to hook a respective side of a pallet to be replaced P placed on the slide element 3 in the collecting site R that is on the side of the window 11 opposite the exchange site I.

Each hooking member 23 comprises a body 27 (FIG. 7) pivoted to the respective bracket element 21 to rotate around an axis parallel to the forward direction, this body 27 has a rod 29 which protrudes from the body in an approximately radial direction; a resilient element 30, associated with body 27 and attested against the bracket, acts on the body to elastically push the rod 29 into a position protruding from the respective bracket element 21.

Said body 27 also includes at least one protruding pin 31 assigned to abut with the slide element 3 or with the floor in the lower position of such bracket element 21 to rotate the body 27 by placing the rod 29 inside the profile of its bracket element 21.

Preferably each bracket element 21 is provided with at least two hooking members 23 whose bodies are rigidly connected by a common pin which can be freely swivelled into their respective rotation seats fixed to or housed into the respective bracket element 21.

When the first pallet to be replaced P passes through the window, it will occupy the exchange site I on the slide element 3 between the bracket elements 21 in abutment with the sliding element or the floor. In such lowered position, the rods 29 fall back into the bracket elements and do not protrude as a result of their rotation due to the contact of the protruding pins 31 with the floor or the sliding element and therefore the rods do not interfere with the sliding of the pallet. The same condition is achieved by lowering the bracket elements 21 after sliding into the collecting site R.

Lifting the bracket elements 21 involves the exit rotation of the rods, which engage in the pallet side recesses by hooking it and lifting it up, releasing the collecting site R on the sliding means, which is then occupied by the second pallet to be replaced, which is slid through the window.

A new lowering and lifting of the bracket elements 21 causes the first pallet to rest on the second, the latter to be hooked and both to be lifted. When a stack of pallets to be replaced is complete, the lowering of the bracket elements 21 to the lower position involves the rotation of the body 27 of each hooking member 23 and the consequent return of the rods 29 which release the base pallet of the stack, which can then be taken from the opposite end with respect to device access or, after lifting of the bulkhead element 9, from the access end of device 1 itself.

As mentioned above, the vertical sides of the bulkhead element 9 are sliding along the respective vertical guides of the uprights 7.

Said bulkhead element 9 is operated for its vertical translation by a lifting actuator element between a lower position, where the lower edge of the bulkhead element 9 abuts with stop elements 35 fixed rigidly or at an adjustable height to the uprights 7 and where such lower edge delimits the upper side of the window 11, at a higher position at a height higher than that of a stack of pallets to be replaced formed in the collecting site R.

In such upper position of the bulkhead element, a transport means T can enter through the access for the load and can access, from the exchange site I, to the collecting site R and can pick up and remove a stack of pallets to be replaced P placed in the collecting site R by accessing the device from said access and said stack from the same side and direction of movement of the load supported respectively by the pallet to be replaced and the replacing pallet.

In general, the translation of the replacing pallet driven by the transport means T may be insufficient to translate the pallet to be replaced completely beyond the window 11. The complete translation beyond window 11 of the pallet is necessary to lift the pallet itself without interfering with the bulkhead element. Such complete translation can be obtained in various ways, for example by placing a thickness in front of the replacing pallet, for example a suitable wooden or plastic beam, capable of pushing the pallet to be replaced beyond the window or, and preferably device 1 can be equipped with a push element 37 placed transversely at the base of the uprights 7 and assigned to provide the pallet to be replaced with a translation push beyond window 11.

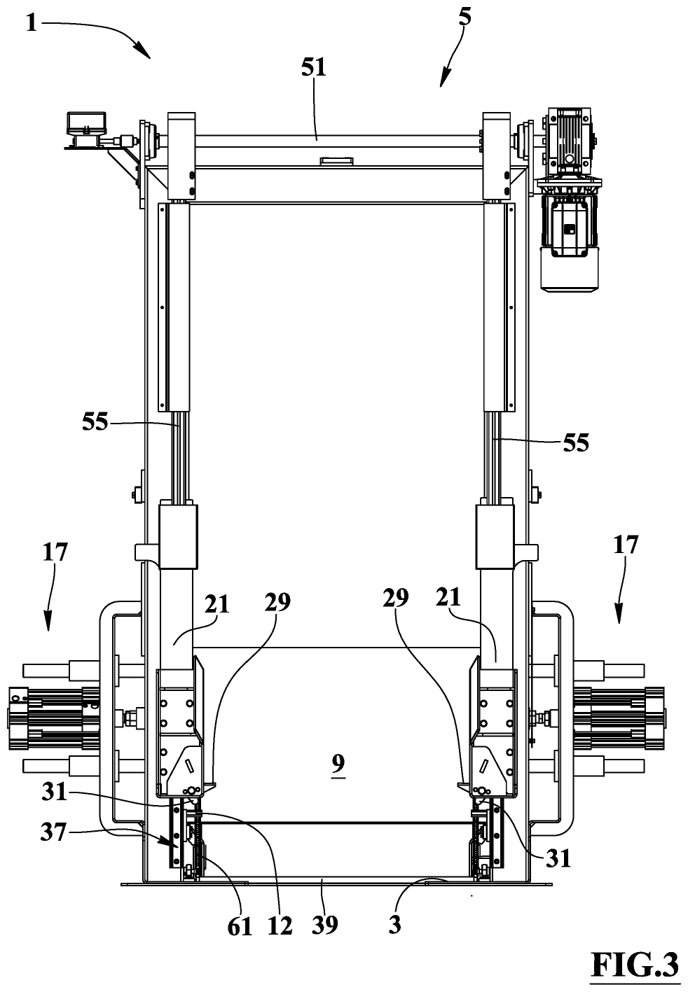

Such push element 37 comprises a transversal pushing bar 39 (FIG. 3 and FIGS. 8-13) whose ends are fixed to eccentric arms 41 swivelling around respective pins connected to the slide element 3 or to the uprights 7, mutually aligned transversely to the slide element 3.

The eccentric arms 41 are operated by at least one rotation actuator element between a first extreme condition in which the push element 39 is in the housings of the side guides of slide element 3 and does not interfere with the pallet's translation and a second extreme condition in which it is in the collecting site R spaced from window 11.

In the passage between these first and second conditions, push element 39 pushes an edge of the pallet to be replaced P from the side of the slide element 3 of the exchange site I to the opposite side, that is in the collecting site R, thus carrying out the complete translation of the pallet to be replaced through the window as shown in FIGS. 11-13.

The vertical movement actuator elements of the two bracket elements 21 and of the bulkhead element 9 and the rotation actuator element for the push element 39 can be of various types and nature and can be independent, for example each one can consist of a linear and/or rotary actuator of known type, or and preferably they can be of the flexible belt or chain member type in the following overall indicated with the term chain.

The lifting actuator element for the sliding of the two bracket elements 21 along the respective uprights 7 comprises a motorized shaft 51 swivelingly connected to the upper portion of the portal element 5 perpendicularly to the uprights 7 and to the longitudinal forward direction and carrying two ring gears 53 each carrying a respective chain 55 whose first end 57 is fixed to the respective bracket elements 21 to translate these bracket elements 21 between the lower position where they match with the slide element 3 or with the floor and hook a pallet P and an upper position where they lift a stack of pallets P allowing the translation of a further underlying pallet P.

The lifting actuator element for the sliding of the bulkhead element 9 along the respective uprights 7 comprises a motorized shaft 51 swivelingly connected to the upper portion of the portal element 5 perpendicularly to the uprights 7 and to the longitudinal forward direction and carrying two ring gears 53 each carrying a respective chain 55 whose second end 59 is fixed to the upper portion of the bulkhead element 9 to lift it and lower it.

Preferably these lifting actuator elements are unified and the motorized shaft 51, ring gears 53 and chains 55 are in common; the two bracket elements 21 are fixed to the ends of the chains on the same side of the device and the bulkhead element 9 is fixed to the opposite ends.

In order to allow the bulkhead element 9 to make a much greater excursion than the bracket elements 21 and to allow independent movements, the chain attachments to the bracket elements 21 are provided with collecting containers 10 for the chain in excess which may accumulate neatly when the bulkhead element is lifted.

The rotation actuator element comprises at least one respective piece of chain 61 having one end fixed to the corresponding end of transversal pushing bar 39 or the corresponding eccentric arms 41 and the other end connected to the first end 57 of chain 55 either directly or by means of a connection 63 attached to bracket element 21 on the same side. It is optionally provided that each upright 7 carries a corresponding flap 12 assigned to slidably meet a piece of chain 61 in order to change its angle in respect to the corresponding eccentric arm 41 so as to orientate favorably the force transmitted from the piece of chain 61 to the eccentric arm 41 that is to increase the angle between these segments and the arm.

This device configuration permits to operate the translation of the shelf and bulkhead elements and the rotation of the pushing bar by using a single motor, for example electric, to drive the single motorized shaft 51.

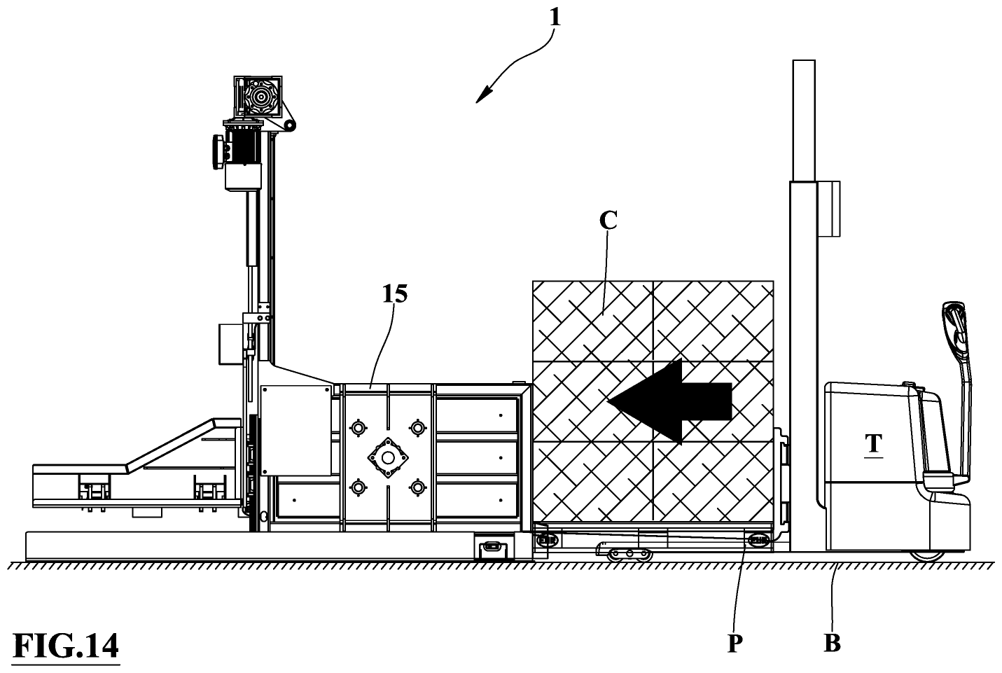

One of the various operations of device 1 includes the following sequence of phases shown in FIGS. 14-23 with the device or its parts viewed from the side, in a succession of phases of separation from a load of the pallet to be replaced and its replacement by a replacing pallet which is inserted under the load supporting it.

FIG. 14: the device is in an initial operative condition with the side walls 19 at the maximum distance from each other, the bulkhead element 9 lowered to delimit window 11 at the top, the lower portion of the bracket elements 21 at a height higher than the lower edge of the bulkhead element 9 and the pushing bar 39 in the concave sites of the slide element 3; a load C and a respective pallet to be replaced P supporting this load are transported by a transport means T and are drawn near the access of device 1;

FIG. 15: the load C and the respective pallet to be replaced P, still kept lifted by the transpallet T, have been placed in the exchange site I with the load matching the bulkhead element 9, the pushers 17 have caused the approach of the side walls 19 which tighten the load only;

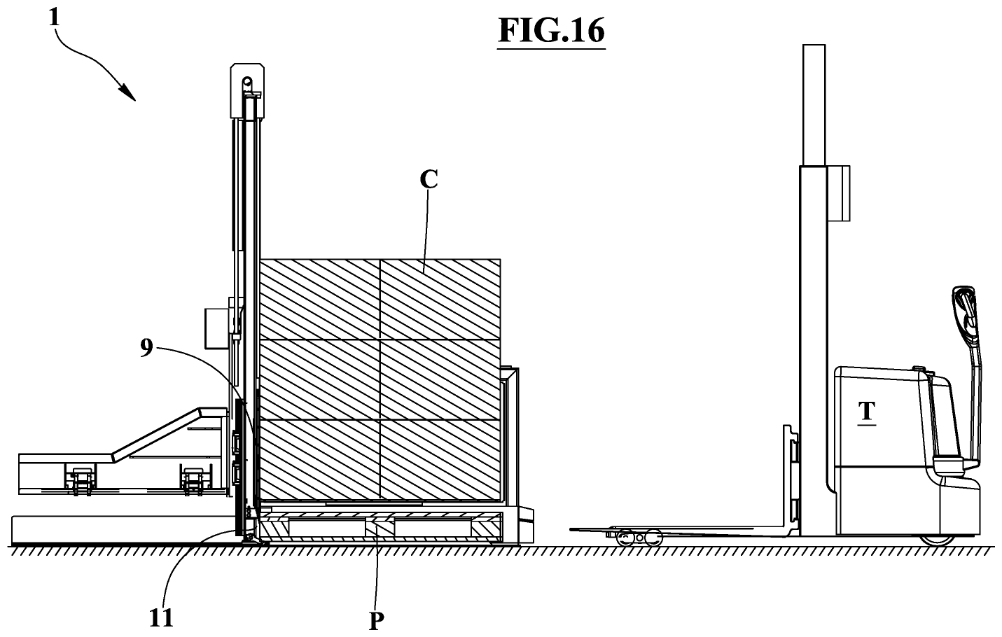

FIG. 16: the transport means T deposited the pallet to be replaced P on the slide element 3 and has been moved away leaving the pallet to be replaced P facing the window 11 while the load C remains slightly lifted thanks to the tightening by the side walls 19 and adherent to the bulkhead element 9;

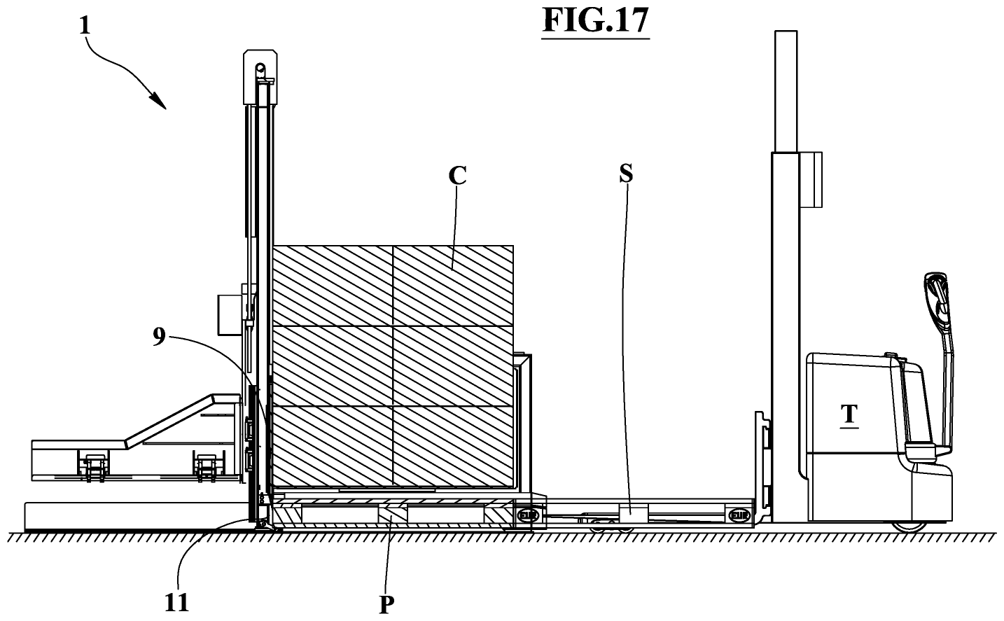

FIG. 17: the transport means T pushes a replacing pallet S against the pallet to be replaced P which starts to move while the load remains slightly lifted;

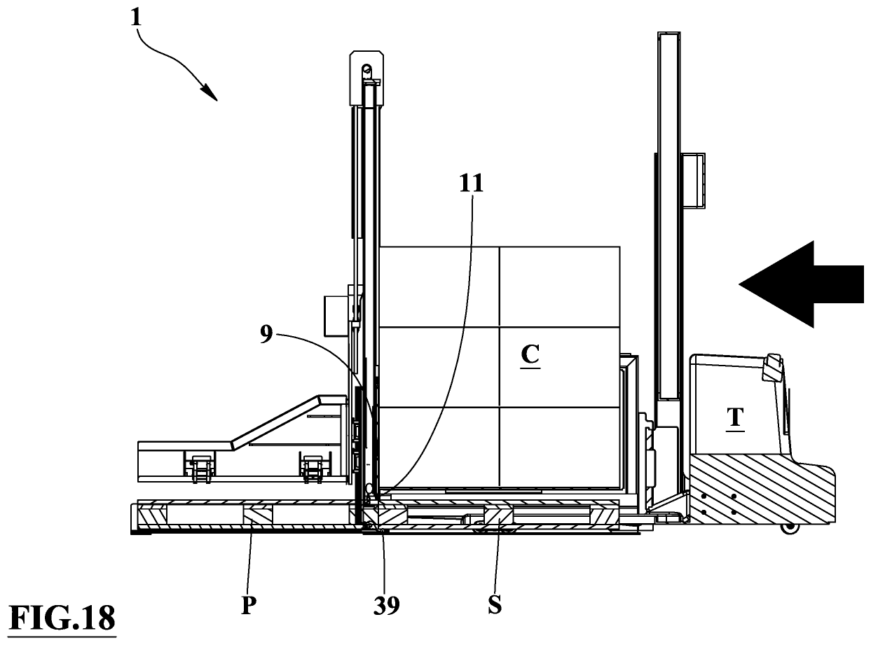

FIG. 18: the transport means T has positioned the replacing pallet S under load C and this replacing pallet S has pushed the pallet to be replaced, almost completely through the window;

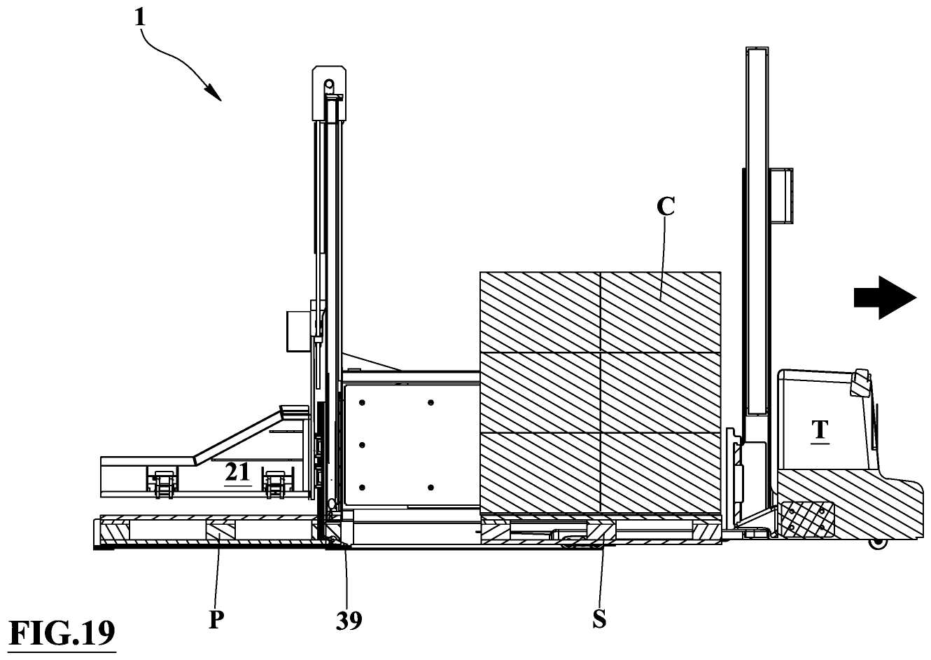

FIG. 19: the pushers 17 have already moved away from each other the side walls 19 that have released the load C by depositing it on the replacing pallet S and the transport means T has picked up and is removing the replacing pallet S with the overlying load C;

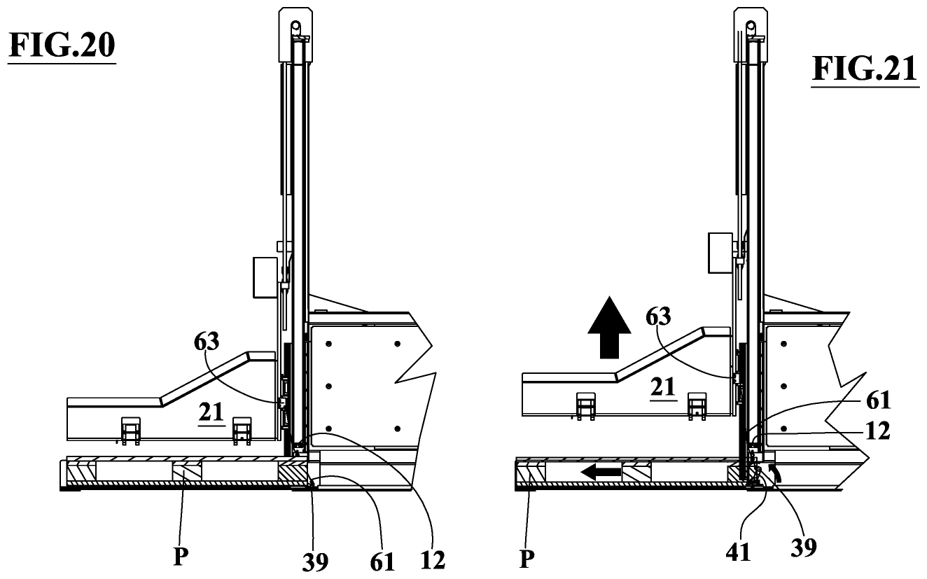

FIG. 20: the transport means T has removed the replacing pallet S with the overlying load C and the pallet to be replaced P is in the same position as FIG. 19 that is with a side edge under the bulkhead element 9;

FIG. 21: the bracket elements 21 are lifted causing the retirement and the sliding of the respective piece of chain 61 which, being connected to the pushing bar 39, rotate it moving it in the opposite direction to the access of the device, in this way the pushing bar 39 acts on the pallet to be replaced P moving it away from the window 11 until the bracket elements 21 are placed in the collecting site R;

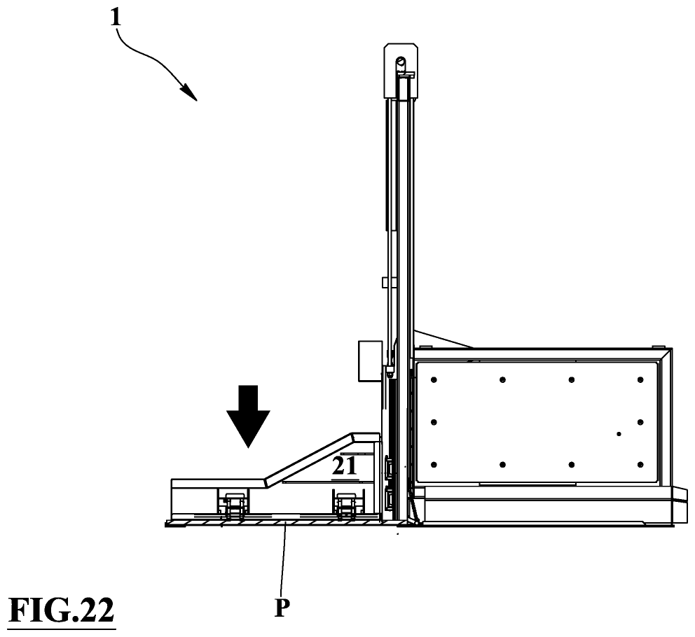

FIG. 22: the bracket elements 21 are lowered by placing side by side the pallet to be replaced P, pushing bar 39 returns to its initial lowered position;

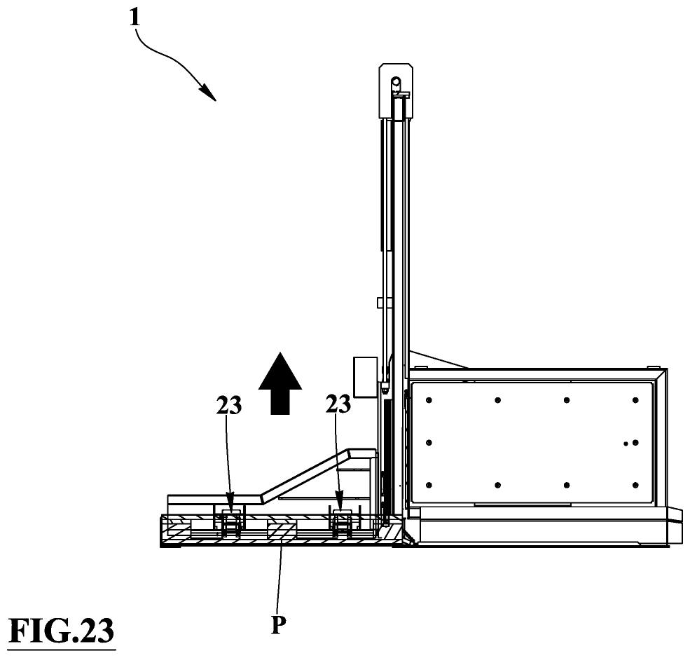

FIG. 23: the hooking members 23 of the bracket elements 21 hook the side edges of the pallet to be replaced P;

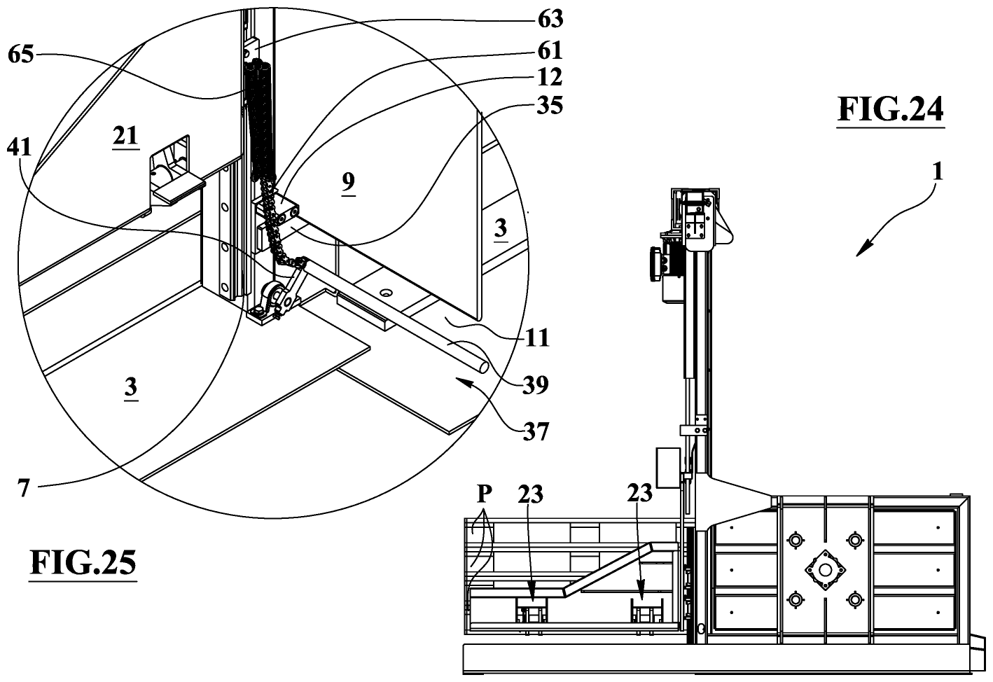

FIG. 24: the device is in the next step after FIG. 23 after four cycles and the bracket elements 21 lift and support four pallets to be replaced P.

When the stack of pallets to be replaced P is complete, this stack can be taken and removed from the end of the device opposite its access end or, after the complete lifting of the bulkhead element 9, from the access end, as also described above.

It is important to note that the forward force which makes the pallets slide in the longitudinal direction along the slide element 3 may be produced by elements external to the device, such as the said transport means T which may consist, for example, of a lift truck or forklift or transpallet or similar known equipment. As an alternative or in addition, the invention provides the device to be equipped with its own means of propelling force assigned to generate advancing force.

A variant of the device, also referable to a basic embodiment consisting at least of the slide element, the portal element, the uprights, the bulkhead element, the window, the transversal pushing bar, the eccentric arms and the rotation actuator element from the transversal pushing bar, refers to an important solution that avoids the possible breakage of the rotation actuator element in some anomalous but possible conditions.

This variant provides that the rotation actuator element (which may be dedicated exclusively to the eccentric arm rotation or, as described below, may perform other functions) also includes a pair of elastic members 65, for example each consisting of a spring or a pair of helical springs interconnected in parallel, or a gas spring or similar.

Each elastic member 65 is inserted along the motion transmission elements for the rotation of the corresponding eccentric arm 41; for example, each elastic member may be connected directly to its respective rotation actuator element, such as linear type, or may be inserted at any other point along the kinematics of the motion transmission elements of the eccentric arm 41, between the rotation actuator element, of any type, and the corresponding eccentric arm. In particular, and as shown in FIG. 25, each elastic member 65 may be inserted between the end of the respective piece of chain 61 opposite the pushing bar 39, or opposite the corresponding eccentric arm 41 and the corresponding connection 63 fixed to the bracket element 21 on the same side.

Alternatively, the end of each elastic member 65 opposite the respective piece of chain 61 may be connected to the first end 57 of chain 55; or the elastic member may be interposed between pushing bar 39 and the respective piece of chain 61.

In normal operation the forces transmitted by the pieces of chain to the eccentric arms are insufficient to cause significant elongation of the elastic member 65 and therefore the pushing bar 39 can translate the pallet.

If pushing bar 39 or one of the eccentric arms 41 or both are blocked, e.g. due to a blocked pallet or any stuck object, the elastic members 65 elongates and prevents the pieces of chain from breaking. As an alternative to the main embodiment, the invention also provides that the first end 57 of each chain 55 is not fixed to the respective bracket element 21 but to the elastic member or that the pieces of chain 61 or, alternatively, the corresponding tie rods, are operated by one or the respective actuators connected to these pieces of chain or tie rods by means of the respective elastic members 65.

A further variant is that the pushing bar 39 is in two pieces each attached to the respective eccentric arm 41 in a protruding and rigid or articulated ratchet tooth mode (also called pawl) pushing the pallet into one direction and allowing the passage into the other.

The two rigid or articulated parts of the pushing bar 39 are preferably made of respective bar pieces and spaced out from each other and the respective eccentric arms 41 can be associated with respective springs, for example spiral or torsion bar, which keep these push bar pieces elastically lowered in their lower position in the absence of the overwhelming lifting forces transmitted to them by the rotation actuator element.

1) A device for exchanging a pallet to be replaced (P) supporting a load (C), with a replacing pallet (S); said device (1), in an operative condition thereof, is located onto an almost horizontal floor or surface (B) and said device (1) is characterized in comprising at least:
a slide element (3) for supporting in a sliding manner said pallets (P, S) and having a width greater than or equal to a width of the pallets (P, S) and the length of the slide element (3) is substantially double a maximum end-to-end length of said pallets (P, S) wherein a longitudinal geometric axis of said slide element (3) defines a longitudinal direction;
a portal element (5) comprising a couple of vertical and mutually spaced uprights (7) fixed to respective and opposed sides of a median portion of the slide element (3);
a bulkhead element (9) connected to said uprights (7) and transversally oriented in respect to the longitudinal direction defined by the slide element (3), and said bulkhead element (9) is vertically spaced in respect to the slide element (3) at least of a preset distance greater than or equal to a height of the pallet to be replaced (P) so as to form a window (11) for the crossing of the pallet to be replaced (P); wherein
in the operative condition, the pallet to be replaced (P) and the respective load (C) are translated along the slide element (3) in said longitudinal direction, up to an exchange site (I) onto the slide element (3) where said pallet to be replaced (P) and the respective load (C) are placed respectively in front of the window (11) and in abutment with, or facing and adjacent to, the bulkhead element (9), wherein a forward force acting in said longitudinal direction onto the pallet to be replaced (P) by means of the replacing pallet (S), causes the insertion of the replacing pallet (S) under the load and the removal of the pallet to be replaced (P) through the window so as to reach a collecting site (R) on a portion of the slide element (3) opposite to the exchange site (I), and thereby obtaining support of the load (C) by the replacing pallet (S) that are together then ready to be picked up with the load laying on top of the replacing pallet (S).

2) The device according to claim 1, further comprising a couple of side arms (15) each connected to a respective upright of the couple of uprights (7) of the at least one portal element (5) for supporting respective sides of the load (C) or said couple of side arms (15) are each provided with a respective pusher (17) for translating corresponding vertical side walls (19) facing said exchange site (I) and parallel to said longitudinal direction where said pushers (17) translate the side walls (19) in mutual approach for gripping the load (C) at least during the exchange of the pallet to be replaced (P) by the replacing pallet (S) and in mutual distancing so as to release the load at the end of said exchange.

3) The device according to claim 2, further comprising an actuator for lifting and lowering both said side arms (15) along the respective uprights (7) at least for allowing stacking two or more loads.

4) The device according to claim 1, further comprising two bracket elements (21), parallel to the forward direction and oriented in the opposite direction to the exchange site with each bracket element (21) connected to a respective upright (7) and vertically sliding along the respective upright (7) by means of at least a lifting actuator element between a lower position, where said each bracket element (21) matches with the slide element (3) or with the floor, and an higher condition where said each bracket element (21) is raised; wherein said each element (21) is provided with a hooking member (23) configured, in an end of a lowering stroke, to hook a respective side of a pallet to be replaced (P) laying onto the slide element (3) in the collecting site (R) or in the window (11) side opposed to the exchange site (I); where each hooking member (23) comprises a body (27) swivelingly hinged to a respective bracket element (21) for rotating around an axis parallel to the longitudinal direction, wherein said body (27) has a rod (29) protruding from the body substantially in a radial direction and elastically protruding outward from the respective bracket element (21) by means of an associated resilient element (30) acting onto said body (27) further comprising a protruding pin (31) configured to match the slide element (3) or the floor in a lowered position of said bracket element (21) to rotate the body (27) and position the rod (29) inside a silhouette of the respective bracket element (21).

5) The device according to claim 1, wherein vertical sides of the bulkhead element (9) slide along the uprights (7) and the bulkhead element (9) is operated by a lifting actuator element between
a lower position, wherein a lower edge of the bulkhead element (9) matches stop elements (35) fixed to the uprights (7) and said lower edge limits an upper side of the window (11), and
an upper position in which said lower edge of the bulkhead clement is higher than a stack of pallets to be replaced (P) positioned into the collecting site (R) allowing a transport means (T) positioned at the exchange site (I) to pick up and carry aw ay said stack from the same side and direction of translation and of putting in and picking up of the load supported respectively by the pallet to be replaced and by the replacing pallet.

6) The device according to claim 1, wherein the slide element (3) comprises two side guides parallel to the longitudinal direction defined by the slide element (3), and that are longitudinal forward guides and provided with respective pallet sliding surfaces, a median portion of each of said forward guides is fixed at a base of a respective upright (7) where said forward guides have respective transversal concave sites extending under said pallet sliding surfaces, said transversal concave sites located upstream, in respect to the longitudinal direction, of an orthogonal projection onto the slide element (3) of the bulkhead element (9); where portions of the sliding guides mutually separated by the transversal sites of the sliding guides equivalent sliding surfaces, or at least portions of the sliding guides on an exchange site (I) side of the opposed sides of the median portion of the slide element (3) have sliding surfaces made of low-drag material.

7) The device according to claim 1, further comprising a pushing element (37) transversally placed at bases of the uprights (7) and comprising a transversal pushing bar (39) wherein the ends thereof are fixed to respective eccentric arms (41) that swivel around respective pivots mutually aligned transversally to the slide element (3) and operated by at least a rotation actuator element between a first extreme condition where the pushing bar (39) does not interfere with pallet translation and a second extreme condition where the pushing bar (39) is in the collecting site (R) spaced from the window (11) where passing from said first and second extreme conditions the pushing bar (37) pushes an edge of the pallet to be replaced (P) from the exchange site (I) side to the collecting site (R) side of the slide element (3).

8) The device according to claim 4, wherein the lifting actuator element for translating the two bracket elements (21) along the respective uprights (7) comprises a motorized shaft (51) axially rotating and connected to the top portion of the portal element (5) perpendicularly to the uprights (7) and to the longitudinal direction that is along the longitudinal direction, and equipped with two ring gears (53) each having a respective chain (55), a first end (57) of each of said chains is fixed to a respective bracket element (21) to translate said bracket elements (21) between the lower position where they match the slide element (3) or the floor and hook a pallet (P) and a raised position where they raise a stack of pallets (P) allowing the translation of an underlying further pallet (P).

9) The device according to claim 5, wherein the lifting actuator element for translating the bulkhead element (9) along the respective uprights (7) comprises a motorized shaft (51) axially rotating and connected to the top portion of the portal element (5) perpendicularly to the uprights (7) and to the longitudinal direction and equipped with two ring gears (53) each having a respective chain (55), wherein second ends (59) of said chains are fixed to an upper portion of the bulkhead element (9) for lifting and lowering the bulkhead element (9).

10) The device according to claim 7, wherein the rotation actuator element comprises at least a respective piece of chain (61) with an end of the piece of chain fixed to a corresponding end of the pushing bar (39) or of the corresponding eccentric arm (41) and with another end of the piece chain (61) connected to the first end (57) of the chain (55) directly or by means of a connection (63) fixed to the respective bracket element (21) on a same side as the corresponding end of the pushing bar (39).

11) The device according to claim 7, wherein the pushing bar (39) of the push element (37) is monolithic or in two separate and distinct parts, where one end of each part is fixed to the respective eccentric arm (41) in a rigid or articulated way in the form of a ratchet tooth to push the pallet in one direction and to allow it to pass in the other.

12) The device according to claim 7, comprising at least one piece of chain (61) or at least one tie rod or attachment having one end fixed to the push bar (39) or to the corresponding eccentric arm (41) and another end fixed to one end of a respective elastic member (65) having an opposite end that is connected to the rotation actuator element.

13) The device according to claim 12, wherein the end of the elastic member (65) connected to the rotation actuator element is connected to a respective chain (55) engaged by a ring gear (53) operated by a motorized shaft (51) where such chain (55), ring gear (53) and motorized shaft (51) act at least as a rotation actuator element.
